(19) United States
(12) Patent Application Publication
(10) Pub. No.: US 2014/0152862 A1
(43) Pub. Date: Jun. 5, 2014

(54) IMAGE PROCESSING APPARATUS, IMAGE PICKUP APPARATUS, IMAGE PICKUP SYSTEM, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Shin Takagi, Tokyo (JP)

(73) Assignee: CANON KABUSHIKI KAISHA, Tokyo (JP)

(21) Appl. No.: 14/087,382

(22) Filed: Nov. 22, 2013

(30) Foreign Application Priority Data
Nov. 30, 2012 (JP) 2012-262876

(51) Int. Cl. H04N 5/225

(52) U.S. Cl. CPC H04N 5/225
USPC 348/222.1

(57) ABSTRACT

An image processing apparatus includes a calculator configured to calculate coordinate conversion information for associating a position of a first image with a position of a second image, a region setting portion configured to set a first region in the first image and set a second region associated with the first region in the second image based on the coordinate conversion information, and an evaluation value obtaining portion configured to compare the first region with the second region to obtain an evaluation value.

### BACKGROUND OF THE INVENTION

1. Field of the Invention

The present invention relates to an image processing apparatus which obtains an evaluation value for each region from two images.

2. Description of the Related Art

In the related art, an evaluation value is obtained from two images involving position shift in such a manner as to calculate the position shift of one image using the other image as a reference image and to generate pixel values by interpolating pixel values of a corresponding position from surroundings to compare with each other for each region. Japanese Patent No. 4760973 discloses, in order to extract an object during a handheld capturing, an image processing method of capturing two images of an image with an object of an extraction target and a background image without the object to perform a positioning and then extracting the object based on differential information (an evaluation between pixels.

However, as disclosed in Japanese Patent No. 4760973, in a case of comparing the image obtained by applying a pixel interpolation and the image to be a positioning reference on which the pixel interpolation is not performed with each other for each region, accuracy of the evaluation value is deteriorated by the change in frequency characteristics of the pixel due to the pixel interpolation.

### BRIEF SUMMARY OF THE INVENTION

The present invention provides an image processing apparatus, an image pickup apparatus, an image pickup system, an image processing method, and a non-transitory computer-readable storage medium capable of obtaining a highly-accurate evaluation value from a plurality of pixels containing a position shift.

An image processing apparatus as one aspect of the present invention includes a calculator configured to calculate coordinate conversion information for associating a position of a first image with a position of a second image, a region setting portion configured to set a first region in the first image and set a second region associated with the first region in the second image based on the coordinate conversion information, and an evaluation value obtaining portion configured to compare the first region with the second region to obtain an evaluation value.

An image pickup apparatus as another aspect of the present invention includes an image pickup element configured to perform photoelectric conversion of an object image to obtain a first image and a second image and the image processing apparatus.

An image pickup system as another aspect of the present invention includes an image pickup optical system and the image pickup apparatus configured to obtain the object image via the image pickup optical system.

An image processing method as another aspect of the present invention includes the steps of calculating coordinate conversion information for associating a position of a first image with a position of a second image, setting a first region in the first image and setting a second region associated with the first region in the second image based on the coordinate conversion information, and comparing the first region with the second region to obtain an evaluation value.

A non-transitory computer-readable storage medium as another aspect of the present invention stores an image processing program for causing an image processing apparatus to execute the steps of calculating coordinate conversion information for associating a position of a first image with a position of a second image, setting a first region in the first image and setting a second region associated with the first region in the second image based on the coordinate conversion information, and comparing the first region with the second region to obtain an evaluation value.

Further features and aspects of the present invention will become apparent from the following description of exemplary embodiments with reference to the attached drawings.

### BRIEF DESCRIPTION OF THE DRAWINGS

FIG. 1 is a block diagram of an image pickup apparatus including an image processing apparatus in each of embodiments.

FIG. 2 is a flowchart of an image processing method in Embodiment 1.

FIGS. 3A and 3B illustrate an example of a reference image and a comparative image, respectively, in Embodiment 1.

FIGS. 4A and 4B illustrate an example of a reference edge image (a reference region) and a comparative edge image (a comparison region), respectively, in Embodiment 1.

FIGS. 5A and 5B are enlarged diagrams of the reference region and the comparison region, respectively, in Embodiment 1.

FIG. 6 is a flowchart of an image processing method in Embodiment 2.

FIGS. 7A and 7B illustrate an example of a reference image and a comparative image, respectively, in Embodiment 2.

FIG. 8 is a diagram of a positioning by a pixel interpolation.

FIG. 9 is a diagram illustrating a change of frequency characteristics by the pixel interpolation.

### DETAILED DESCRIPTION OF THE PREFERRED EMBODIMENTS

Exemplary embodiments of the present invention will, be described below with reference to the accompanied drawings. In each of the drawings, the same elements will be denoted by the same reference numerals and the duplicate descriptions thereof will be omitted.

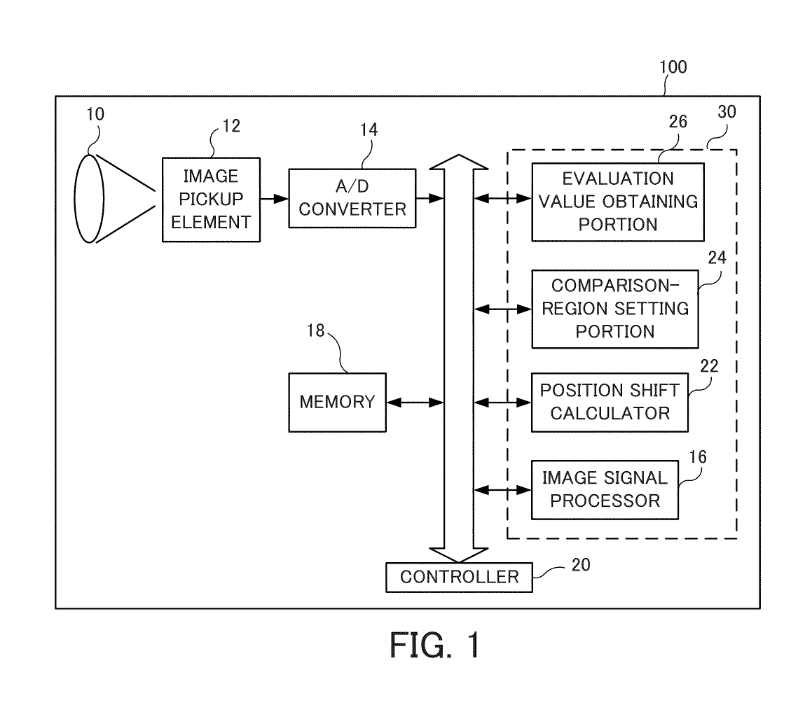

First of all, referring to FIG. 1, a configuration of an image pickup apparatus including an image processing apparatus in the present embodiment will be described. FIG. 1 is a block diagram of an image pickup apparatus 100. The image pickup apparatus 100 compares two images (a plurality of images) containing a position shift captured by changing an in-focus position for each region and obtains an evaluation value to obtain distance information for each region.

In the image pickup apparatus 100, an image pickup lens 10 (an image pickup optical system) optically forms a shot image on an image pickup element 12. The image pickup element 12 performs a photoelectric conversion for the shot image (an object image) to convert the shot imago into an electric signal (an analog signal). The image pickup element 12 is configured to include a plurality of color filters. An A/D converter 14 converts an analog signal output from the image pickup element 12 into a digital signal. In addition, the image pickup apparatus 100 in the present embodiment is integrally configured with the image pickup lens 10 (the image pickup optical system) and an image pickup apparatus body, but the image pickup apparatus 100 is not limited to this. The embodiment can also be applied to an image pickup system that is configured by an image pickup apparatus body and an image pickup optical system (a lens apparatus) removably mounted on the image pickup apparatus body.

An image signal processor 16 performs various types of image signal processing such as a synchronization processing, a white balance processing, a gamma processing, or an NR processing on image data (an image signal) obtained by taking an image. The image signal processor 16 develops the image data after the processing and stores the developed image data in a memory 18. The memory 18 is a volatile memory (a storage portion) that stores temporarily the image data obtained by taking an image. A controller 20 controls data flow among the A/D converter 14, the memory 18, the image signal processor 16, a position shift calculator 22, a comparison-region setting portion 24, and an evaluation value obtaining portion 26.

The position shift calculator 22 (a calculator) calculates a position shift between two images (a first image and a second image) obtained by the image pickup element 12 to calculate coordinate conversion information for associating positions of two images with each other. The comparison-region setting portion 24 (a region setting portion) sets a reference region (a first region) with respect to a reference image (a first image) which is one of the two images and sets a comparison region (a second region) with respect to a comparative image (a second image) which is the other of the two images. The comparison region is determined based on the coordinate conversion information calculated by the position shift calculator 22.

The evaluation value obtaining portion 26 compares the reference region (the first region) which is set with respect to the reference image, and the comparison region (the second region) which is set with respect to the comparative image, to obtain the evaluation value. In the present embodiment, the evaluation value obtaining portion 26 performs an edge extraction for each region of the reference region and the comparison region. Then, the evaluation value obtaining portion 26 obtains the evaluation value, by comparing values obtained by integrating absolute values of edge amplitudes for each pixel within these two regions. In the present embodiment, the image processing apparatus 30 is configured to include the image signal processor 16, the position shift calculator 22, the comparison-region setting portion 24, and the evaluation value obtaining portion 26.

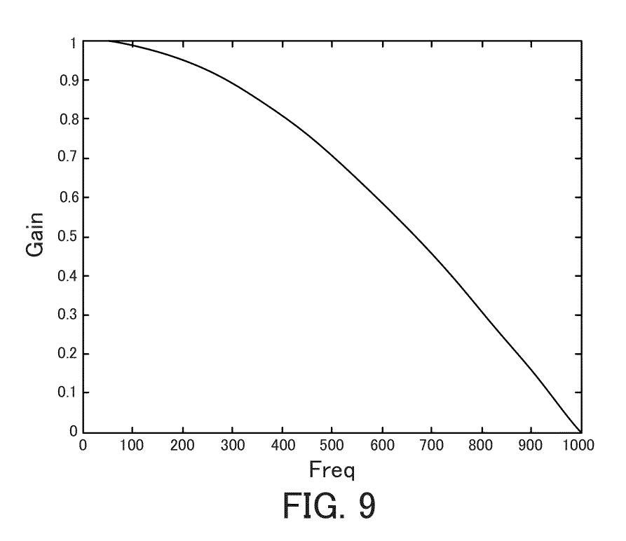

As in the related art, however, when an image obtained by performing a pixel interpolation and an image for which the pixel, interpolation has not been performed, which is a reference of the positioning are compared with each other for each region, the accuracy is deteriorated by the change in the frequency characteristics of the pixel due to the pixel interpolation. For example, as a result of detecting the position shift between two images, when the pixel is positioned in a state horizontally shifted by 0.5 pixels and is generated by a linear interpolation as illustrated in FIG. 8, a low-pass filter of the frequency characteristics is applied as illustrated in FIG. 9. For this reason, the frequency characteristics are changed only for the positioned image. Thus, the image processing method of the present embodiment obtains a highly-accurate evaluation value without interpolating the pixel. A specific embodiment of the image processing method will be described below.

### Embodiment 1

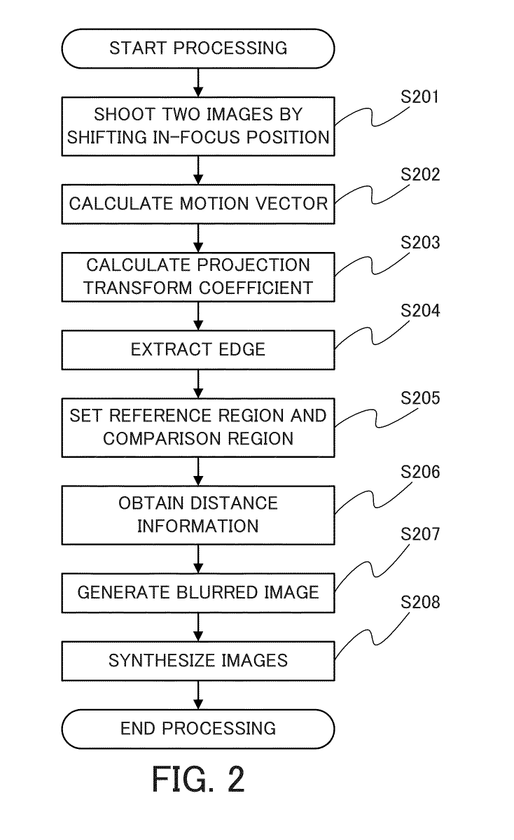

First of all, referring to FIGS. 2 to 5, an image processing method in Embodiment 1 of the present invention will be described. FIG. 2 is a flowchart of the image processing method (a method of obtaining the evaluation value) in the present embodiment. Each step of FIG. 2 is mainly performed by the image processing apparatus 30 based on a command of the controller 20.

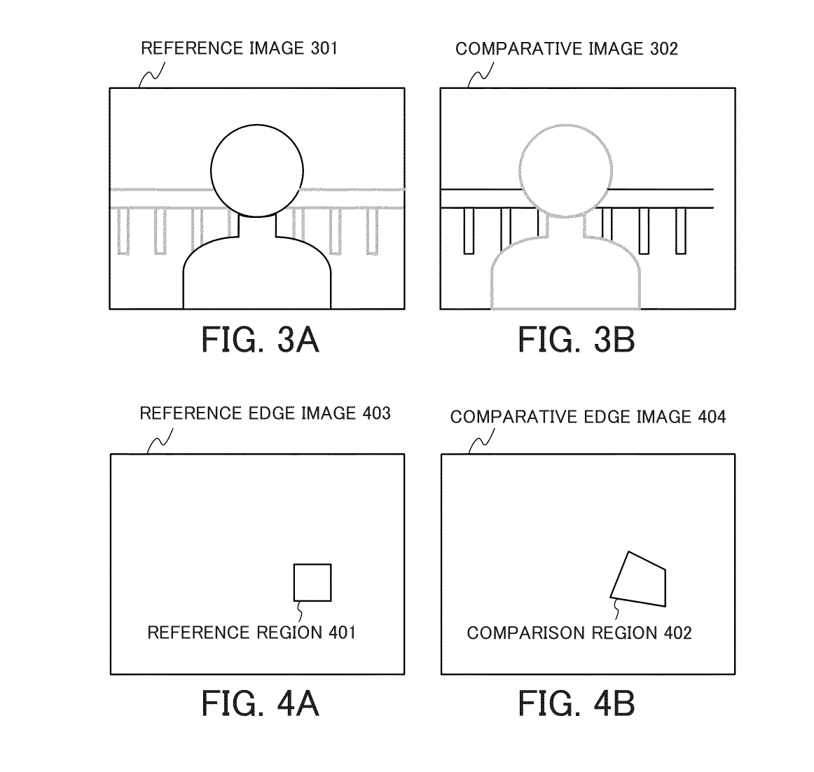

First of all, in step S201, the image pickup apparatus 100 takes two images (a first image and a second image) by shifting the in-focus position. Here, one image (for example, a first shot image) is referred to as a reference image 301 (a first image), and the other image (for example, a second shot image) is referred to as a comparative image 302 (a second image). FIGS. 3A and 3B illustrate an example of the two images obtained by shooting images, FIG. 3A illustrates the reference image 301, and FIG. 3B illustrates the comparative image 302. The reference image 301 is an image which is focused on the object. On the other hand, the comparative image 302 is an image which is focused on the background. In addition, in the present embodiment, since the two images are shot under a condition of holding the image pickup apparatus 100 with hand, the position shift occurs between the reference image 301 and the comparative image 302 (the two images).

Next, the position shift calculator 22 calculates a motion vector between the two images to calculate the coordinate conversion information for associating the position shift between the two images. That is, the position shift calculator 22 calculates the coordinate conversion information based on the motion vector between the reference image 301 (the first image) and the comparative image 302 (the second image).

Specifically, in step S202, the position shift calculator 22 divides each of the reference image 301 for the positioning and the comparative image 302 for calculating the position shift (an amount of the position shift) with respect to the reference image 301 into a plurality of regions (sub-regions), respectively. Then, the position shift calculator 22 calculates the motion vector by obtaining the position on shift amount between the reference image 301 and the comparative image 302 for each of these regions (divided regions). As a method of calculating the amount of the position shift in the present embodiment, for example a method disclosed in Japanese Patent Laid-open No. 2009-301181 is used. According to this method, a correlation value is obtained while the sub-region of the reference image 301 moves in the sub-region of the comparative image 302, and the motion vector up to the position to be the minimum correlation value is referred to as the amount of the position shift in the sub-region. In addition, for example, the sum of absolute differences (SAD) is used as the correlation value.

Subsequently, in step S203, the position shift calculator 22 calculates the coordinate conversion information for associating the position shift between the two images, based on the amount of the position shift calculated for each sub-region. In the present embodiment, the coordinate conversion information is a projection transform coefficient, and the projection transform coefficient is a coefficient indicating a deformation of the object image. Further, only one projection transform coefficient may be calculated with respect to one image, or alternatively, different projection transform coefficients may be calculated for each sub-region. In the present embodiment, the projection transform coefficient is used as the coordinate conversion information, but the embodiment is not limited to this. Instead of the projection transform coefficient, other types of coordinate conversion information such as an affine transform coefficient may be calculated.

Next, in step S204, the image signal processor 16 performs an edge extraction processing using a band-pass filter for each of the reference image 301 and the comparative image 302 to generate a reference edge image 403 and a comparative edge image 404. FIG. 4A illustrates an example of the reference edge image 403, and FIG. 4B illustrates an example of the comparative edge image 404.

Next, in step S205, the comparison-region setting portion 24 sets the reference region 401 with respect to the reference edge image 403. In addition, the comparison-region setting portion 24 sets the comparison region 402 with respect to the comparative edge image 404 based on the projection transform coefficient calculated in step S203.

A method of setting the reference region 401 and the comparison region 402 will be described below in detail. First of all, the comparison-region setting portion 24 sets the rectangular reference region 401 around a target pixel which obtains distance information in the interior of the reference edge image 403. Subsequently, the comparison-region setting portion 24 performs the coordinate conversion for four corners (four vertexes) of the reference region 401 using the following Expressions (1) and (2) based on the projection transform coefficient calculated by the position shift calculator 22, to set the comparison region 402 with respect to the comparative edge image 404.

x′=(ax+by+c)÷(dx+ey+1) (1)

y′=(fx+gy+i)÷(dx+ey+1) (2)

In Expressions (1) and (2), coefficients a, b, c, d, e, f, and g are the projection transform coefficients calculated in step S203. Symbols x and y indicate an x-coordinate and a y-coordinate of one corner among four corners (four vertexes) of the reference region 401, respectively. Symbols x′ and y′ indicate an x-coordinate and a y-coordinate of one corner among four corners (four vertexes) of the comparison region 402, respectively, which are a position of one corner of the comparative, edge image 404 corresponding to one corner of the reference region 401. The comparison-region setting portion 24 calculates positions of three corners of the comparative edge image 404 corresponding to remaining three corners of the reference region 401, respectively, based on Expressions (1) and (2) to obtain coordinates of four corners of the comparison region 402.

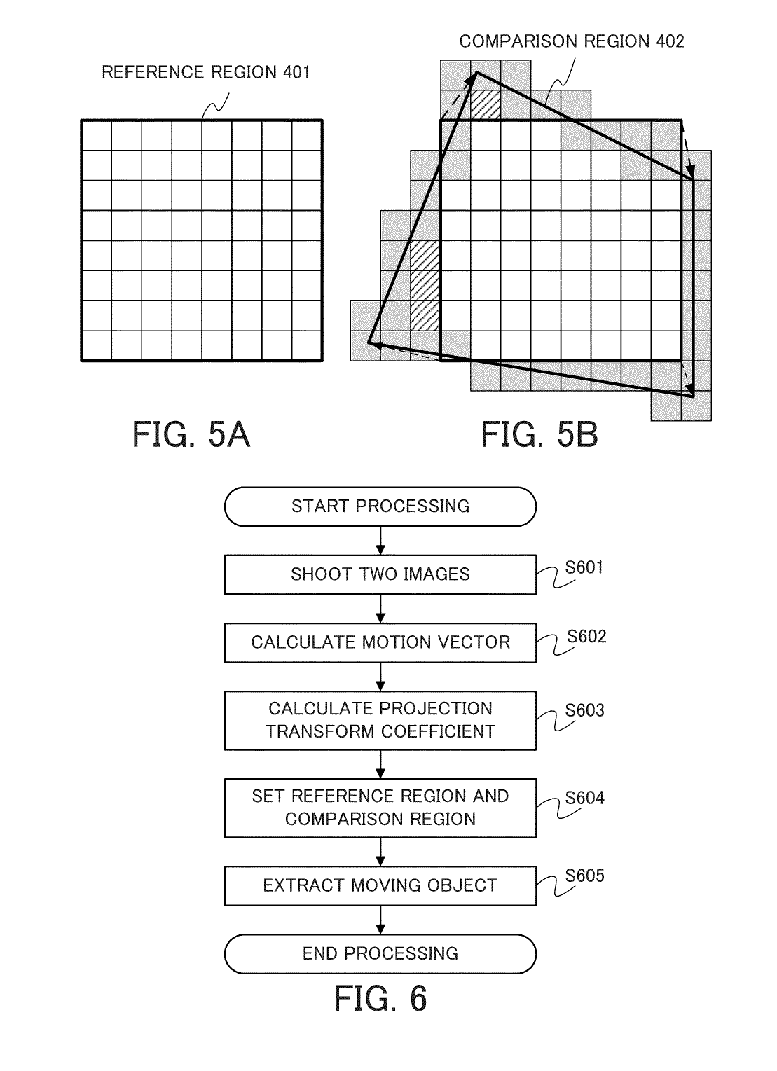

FIGS. 5A and 5B are enlarged diagrams of the reference region 401 and the comparison region 402, respectively, and FIG. 5A illustrates the reference region 401 and FIG. 5B illustrates the comparison region 402. Arrows of wavy lines indicated in FIG. 5B represent that the coordinates of four corners of the reference region 401 have been converted into the positions indicated by the arrows of wavy lines according to the method described above. Thus, the comparison-region setting portion 24 sets a region, which has each vertex at points obtained with respect to each vertex of the reference region 401 using the coordinate conversion information, as the comparison region 402.

In the present embodiment, the method of determining the comparison region 402 based on the rectangular reference region 401 is described, but the embodiment is not limited to this. For example, the reference region 401 may be set to a polygonal shape, and then the comparison region 402 may be set by performing the coordinate conversion for each vertex of the polygonal shape. Alternatively, the reference region 401 may be set to an arbitrary shape, and then the comparison region 402 may be set by performing the coordinate conversion for each pixel included in the reference region 401. In this case, the comparison-region setting portion 24 sets a region which includes pixels obtained using the coordinate conversion information with respect to the pixels included in the reference region 401, as the comparison region 402.

Next, in step S206, the evaluation value obtaining portion 26 compares the reference region 401 with the comparison region 402 to obtain the evaluation value of the regions. Specifically, the evaluation value obtaining portion 26 obtains a difference between signal values (hereinafter, referred to as “edge integral values”) each obtained by integrating an absolute value of the edge amplitude of the pixel in each region of the reference edge image 403 and the comparative edge image 404, as an evaluation value. As will be described below, the evaluation value of the present embodiment is used to obtain the distance information of foreground or background.

As described above, the evaluation value obtaining portion 26 compares the edge integral value of the reference region 401 with the edge integral value of the comparison region 402 to obtain the evaluation value. In the embodiment, the comparison region 402 is not necessarily the rectangular shape. When the comparison region 402 has a quadrangular shape is deformed quadrangular shape) other than the rectangular shape, a target region (a target pixel) of the comparison region 402, for which an edge integral is performed, is a pixel included fully in the comparison region 402. For example, in the case of the comparison region 402 illustrated in FIG. 5B, the target pixels are white pixels and diagonal-lined pixels included inside the comparison region 402.

In addition, the number of pixels of the reference region 401, which is taken as a target of the edge integral, is 64, whereas the number of pixels of the comparison region 402, which is taken as a target of the edge integral, is 59. For this reason, in the present embodiment, it is preferred that the edge integral value is normalized in accordance with the number of the pixels which are taken as a target of the edge integral. Specifically, a value which is normalized by multiplying 64/59 by the edge integral value of the comparison region 402 is set to a final edge integral value of the comparison region 402. Thus, the evaluation value obtaining portion 26 may normalize the evaluation value in accordance with sizes of the reference region 401 (the first region) and the comparison region 402 (the second region).

Furthermore, with respect to pixels (gray pixels) included partially inside the comparison region 402, it is possible to add to the edge integral value by multiplying a weight (performing a weighting) depending on a fraction (a ratio) included inside the comparison region 402. Thus, the evaluation value obtaining portion 26 may obtain the evaluation value by changing the weight for each pixel included in the comparison region 402 (the second region).

Subsequently, the evaluation value obtaining portion 26 (the controller 20) determines (obtains) the distance information based on the obtained evaluation value. The evaluation value obtaining portion 26 compares the edge integral values for each region as described above. In a region where the edge integral value of the comparative edge image 404, which is focused on the background, decreases with respect to the reference edge image 403, which is focused on the foreground object, an image in the comparative edge image 404 is blurred with respect to the reference edge image 403. Therefore, the region is determined to be the foreground. Conversely, when the edge integral value of the comparative edge image 404 increases with respect to the reference edge image 403, the image in the comparative edge image 404 is focused with respect to the reference edge image 403. Therefore, the region is determined to be the background. In the present embodiment, the difference between the edge integral values (the signal values) is used as the evaluation value, but the embodiment is not limited to this. A ratio of the edge integral value may also be used, or alternatively, the edge integral value for calculating the evaluation value may be used by combining edge integral values of edges extracted by a plurality of filters having different frequency characteristics.

Next, in step S207, the image signal processor 16 (the controller 20) generates a blurred image, in which an entire image is blurred, by applying a blur filter to the reference image 301. As the blur filter, for example, a low-pass filter having the frequency characteristics passing through a low frequency region is selected.

Next, in step S208, the image signal processor 16 (the controller 20) synthesizes (combines) the reference image 301 and the blurred image generated in step S207 based on the evaluation value (the distance information) calculated in step S206. The reference image 301 is referenced to the foreground region which is determined as a foreground by the distance information. On the other hand, the blurred image generated in step S207 is referenced to the background region which is determined as a background by the distance information. Then, the image signal processor 16 (the controller 20) may synthesize the foreground and the background to generate the background-blurred image in which the object region (the foreground region) is focused and the background region is blurred.

According to the present embodiment, the shape of the comparison region is changed without having any influence on the pixel value based on the coordinate conversion coefficient for the positioning, and thus the evaluation value (the distance information) can be obtained for each region by reducing the influence of the positioning.

### Embodiment 2

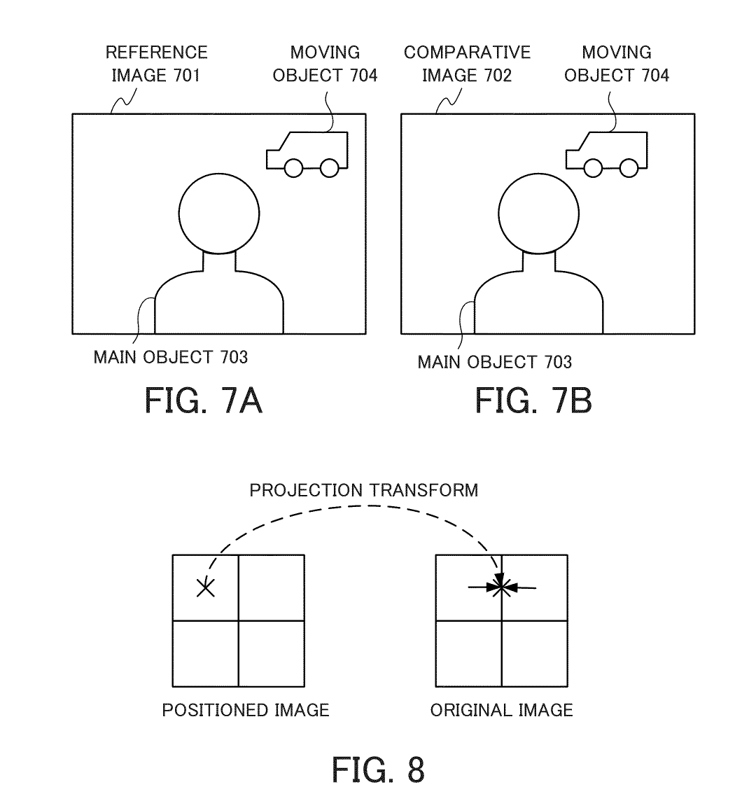

Next, referring to FIGS. 6, 7A, and 7B, an image processing method in Embodiment 2 of the present invention will be described. The image processing apparatus 30 of the present embodiment obtains the evaluation value for each region from two shot images containing a position shift to extract a moving object region in an image. That is, the evaluation value obtaining portion 26 compares the reference region set in the reference image and the comparison region set in the comparative image with each other to obtain the evaluation value (moving object information) and to extract the moving object region. Thus, the evaluation value of the present embodiment is used to determine the moving object region.

FIG. 6 is a flowchart of the image processing method (a method of obtaining the evaluation value) in the present embodiment. Each step of FIG. 6 is mainly performed by the image processing apparatus 30 based on a command of the controller 20. First of all, in step S601, the image pickup apparatus 100 captures (shoots) two images. In the embodiment, one image (for example, a first shot image) is referred to as a reference image 701, and the other image (for example, a second shot image) is referred to as a comparative image 702.

FIGS. 7A and 7E illustrate an example of two images obtained, by capturing (shooting), and FIG. 7A illustrates the reference image 701 and FIG. 7B illustrates the comparative image 702. In the reference image 701 and the comparative image 702, a main object 703 is not moving, on the other hand, a moving object 704 is moving. In addition, in the present embodiment, since the two images are shot under a condition of holding the image pickup apparatus 100 with hand, the position shift occurs between the two images.

Next, in step S602, the position shift calculator 22 calculates the motion vector between the two images. Then, in step S603, the position shift calculator 22 calculates the coordinate conversion information (the projection transform coefficient) for associating the position shift between the two images. Steps S602 and S603 of the present embodiment are the same as steps S202 and S203 of Embodiment 1, respectively.

Next, in step S604, the comparison-region setting portion 24 sets the reference region 401 and the comparison region 402. Basically, step S604 of the present embodiment is the same as step S205 of Embodiment 1. In the present embodiment, however, the reference region 401 and the comparison region 402 are set to the reference image 701 and the comparative image 702, respectively.

Next, in step S605, the evaluation value obtaining portion 26 (the controller 20) obtains the evaluation value of each region to extract the moving object region within the image. In the present embodiment, the evaluation value obtaining portion 26 obtains a total sum of luminance values (signal values) of the pixels inside the rectangular reference region 401 around the target pixel and the pixels inside the comparison region 402 corresponding to the reference region 401, as the evaluation value. Then, when a difference or a ratio between the total sum of the luminance values of the reference region 401 and the comparison region 402 is a predetermined value or more, the evaluation value obtaining portion 26 determines the region as the moving object (the moving object region). In the present embodiment, the total sum of color differences, the sum of signal values of different color spaces, or the total sum of signal values of various color sections may also be compared by weighting. In addition, on, similarly to Embodiment 1, even in pixels included partially inside the comparison region 402, it is possible to add to the total sum of signal values by performing the weighting depending on the fraction (the ratio) included inside the comparison region 402.

According to the present embodiment, the shape of the comparison region is changed without having any influence on the pixel, value based on the coordinate conversion coefficient for the positioning, and thus the evaluation value (the total sum of luminance values) can be obtained, for each region by reducing the influence of the positioning.

Therefore, according, to each embodiment, an image processing apparatus, an image pickup apparatus, an image pickup system, and an image processing method capable of obtaining a highly-accurate evaluation value from a plurality of pixels containing a position shift can be provided. Also, according to each embodiment, a non-transitory computer-readable storage medium which stores an image processing program for causing the image processing apparatus to execute the image processing method can be provided.

As described above, although preferred embodiments are described, the present invention is not limited to these embodiments, and various changes and modifications can be made within the scope of the invention.

While she present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-262376, filed on Nov. 30, 2012, which is hereby incorporated by reference herein in its entirety.

What is claimed is:

1. An image processing apparatus comprising:
a calculator configured to calculate coordinate conversion information for associating a position of a first image with a position of a second image;
a region setting portion configured to set a first region in the first image and set a second region associated with the first region in the second image based on the coordinate conversion information; and
an evaluation value obtaining portion configured to compare the first region with the second region to obtain an evaluation value.

2. The image processing apparatus according to claim 1, wherein the calculator calculates the coordinate conversion information based on a motion vector between the first image and the second image.

3. The image processing apparatus according to claim 1, wherein the coordinate conversion information is a projection transform coefficient indicating a deformation of an object image.

4. The image processing apparatus according to claim 1, wherein the evaluation value obtaining portion obtains the evaluation value without interpolating pixels included in the first region and the second region.

5. The image processing apparatus according to claim 1, wherein the evaluation value obtaining portion normalizes the evaluation value in accordance with sizes of the first region and the second region.

6. The image processing apparatus according to claim 1, wherein the evaluation value obtaining portion changes a weight for each pixel included in the second region to obtain the evaluation value.

7. The image processing apparatus according to claim 1, wherein the evaluation value obtaining portion compares edge integral values of the in region and the second region with each other to obtain the evaluation value.

8. The image processing apparatus according to claim 1, wherein the evaluation value obtaining portion compares differences between signal values of the first region and the second region to obtain the evaluation value.

9. The image processing apparatus according to claim 1, wherein the region setting portion sets a region, which has each vertex at points obtained using the coordinate conversion information with respect to each vertex of the first region, as the second region.

10. The image processing apparatus according to claim 1, wherein the region setting portion sets a region, which includes a pixel obtained using the coordinate conversion information with respect to a pixel included in the first region, as the second region.

11. The image processing apparatus according to claim 1, wherein the evaluation value is used to obtain distance information.

12. The image processing apparatus according to claim 1, wherein the evaluation value is used to determine a moving object region.

13. An image pickup apparatus comprising:
an image pickup element configured to perform photoelectric conversion of an object image to obtain a first image and a second image; and
an image processing apparatus according to claim 1.

14. An image pickup system comprising:
an image pickup optical system; and
an image pickup apparatus according to claim 13, configured to obtain the object image via the image pickup optical system.

15. An image processing method comprising the steps of:
calculating coordinate conversion information for associating a position of a first image with a position of a second image;
setting a first region in the first image and setting a second region associated with the first region in the second image based on the coordinate conversion information; and
comparing the first region with the second region to obtain an evaluation value.

16. A non-transitory computer-readable storage medium which stores an image processing program for causing an image processing apparatus to execute the steps of:
calculating coordinate conversion information for associating a position of a first image with a position of a second image;
setting a first region in the first image and setting a second region associated with the first region in the second image based on the coordinate conversion information; and
comparing the first region with the second region to obtain an evaluation value.
